(19) United States
(12) Patent Application Publication
(10) Pub. No.: US 2010/0148989 A1
(43) Pub. Date: Jun. 17, 2010

(54) Safety or Alert Device

(76) Inventors: Mark P. Hawkins, Epping (AU); Martin Khoo, Epping (AU)

Correspondence Address: MARSHALL, GERSTEIN & BORUN LLP, 233 SOUTH WACKER DRIVE, 6300 WILLIS TOWER, CHICAGO, IL, 60606-6357, US

(21) Appl. No.: 12/635,969

(22) Filed: Dec. 11, 2009

(30) Foreign Application Priority Data
Dec. 12, 2008 (AU) 2008101198
Dec. 12, 2008 (AU) 2008255236

(51) Int. Cl. G08G 1/095

(52) U.S. Cl. 340/944

(57) ABSTRACT

The invention resides in an alert device, the device including a housing containing one or more flashing light sources and one or more non-flashing light sources, wherein both flashing and non-flashing light sources are arranged to emit light away from the housing, and optionally a detector adapted to detect the movement of an object into an area proximate to the housing, and control circuitry connected or connectable to a power supply, wherein the control circuitry is adapted to light the one or more flashing light sources in response to a signal from the detector indicating that a moving object has been detected.

### TECHNICAL FIELD

The present invention broadly relates to safety or alert devices.

One embodiment of the invention relates to the field of safety or alert devices for pedestrians. Another embodiment of the invention relates to the field of safety or alert devices for vehicles.

### BACKGROUND

Despite the provision of designated pedestrian road crossings, which are marked by indicators on the road and/or adjacent to the road, there continues to be accidents at pedestrian road crossings.

This is particularly the case during periods where motorists and or pedestrians have poor visibility, such as overcast, foggy, or rainy conditions, at dawn or dusk, or at night.

Pedestrian crossings near schools are considered particularly high risk. This increased risk may be due to a number of factors, including the relatively high volume of pedestrian traffic during short periods of the day, the relative inexperience of children in comparison to adults, the reduced visibility of children due to their lesser height in comparison to adults and/or that periods of high use may correspond to times when drivers of vehicles may also be subjected to sun strike.

Another area of high risk may be where road workers are performing maintenance on the road, especially maintenance conducted during twilight and at night. Another problem for drivers of vehicles is navigating around objects and fixtures. Failure to navigate accurately can result in damage to the vehicle and/or to the object or fixture.

For at least these reasons, there is a continuing need to improve the safety of pedestrians, road workers, and other road users.

### SUMMARY OF THE INVENTION

According to a first aspect, the invention broadly resides in an alert device, the device including a housing containing at least one light source arranged to emit light away from the housing, and a power supply.

According to a second aspect, the invention broadly resides in a pedestrian alert device, the device including a housing containing at least one light source arranged to emit light away from the housing, a power supply.

According to a further aspect, the invention broadly resides in an alert device, the device including a housing containing at least one light source arranged to emit light away from the housing, a detector adapted to detect the movement of an object into an area proximate to the housing, and control circuitry connected or connectable to a power supply, wherein the control circuitry is adapted to light the at least one light source in response to a signal from the detector indicating that a moving object has been detected.

According to a still further aspect, the invention broadly resides in a pedestrian alert device, the device including a housing containing at least one light source arranged to emit light away from the housing, a pedestrian detector adapted to detect the presence of a pedestrian proximate to the device, and control circuitry connected or connectable to a power supply, wherein the control circuitry is adapted to light the at least one light source in response to a signal from the pedestrian detector indicating that a pedestrian has been detected.

At least a part of the housing may be constructed from a high impact polymer material. The housing may be portable and contain at least each light source and the control circuitry. If not portable, the housing may be permanently fixed in a final position. The housing may be fixed by a locking plate located for example on the ground, or by conventional methods such as cement or bitumen. The housing according to the invention may be used interchangeably with both a portable base, or with a permanently fixed base fitting. Permanent base fittings are preferably constructed from steel, aluminium, or similar material.
The housing may further contain the pedestrian detector and may further contain the power source, which may be a battery. The housing may be between approximately 1 m and 2 m tall. In a preferred embodiment as currently contemplated, the housing may be approximately 1.5 m tall and similar in appearance to the bollard depicted in FIG. 4.

The housing may include a base and a stalk that extends upwards from the base and contains the at least one light source. The base may have a width of approximately 0.4-0.75 m, preferably 0.6-0.7 m. The device may further include one or more reflectors facing outwards from the housing.

The at least one light source may include a first and a second light source, wherein the first and second light sources are vertically separated and both emit light from the housing in the same direction. The first and second light sources may be flashing lights, such as strobe or LED lights.

The first and second light sources may be separated by a distance of approximately between 100 mm and 200 mm. The device may further include at least one further light source arranged to emit light away from the housing in the same direction as the first and second light sources and located vertically between the first and second light sources. The further light source may be a non-flashing, or non-strobe, light source. The first and second light sources and the at least one further light source may be substantially vertically aligned.

The device may include at least two light sources, with at least one emitting light from the housing in a first direction and at least one emitting light from the housing in a second direction, opposite to the first direction. There may be a plurality of light sources arranged to emit light in each of the first direction and the second direction.

For example, in one embodiment the device may include at least two flashing lights and one non-flashing light facing a first direction, and at least two flashing lights and one non-flashing lights facing a second direction opposite to the first direction. The flashing lights may optionally be strobe or LED lights, whereas the non-flashing lights may optionally be led lights.

As mentioned above, at least one of the light sources may be flashed on and off. In one embodiment at least one of the light sources is a flashing strobe or LED light. In one embodiment there are at least two light sources that are flashed on and off and in another embodiment there are at least three light sources that are flashed on and off. A preferred embodiment as presently contemplated includes four flashing lights arranged to emit light from the housing in substantially the same direction and may also include a second set of four flashing lights arranged to emit light from the housing in substantially the opposite direction. When in use, the lights may be lit substantially randomly, for example in a random or substantially random sequence, and without being synchronized.

In one embodiment the light sources are dc powered strobe lights.

In a very preferred embodiment, the device is fitted with a detector that is a pedestrian detector which includes a passive infrared (PIR) sensor or an ultrasonic detector, or in fact any modular proximity determining device. In alternative embodiments, the pedestrian detector may be another movement sensor, including but not limited to a video camera. In still further alternative embodiments, the pedestrian detector may be a pressure pad located proximate the housing and connected to the control circuitry.

In an alternative embodiment, activation of the device may be via a button or other switch operable by a pedestrian to indicate his or her presence at the device. Combinations of two or more different detectors may also be used.

In one embodiment, the device includes a means to switch the at least one light source permanently on, and may or may not include a detector. The device may include a light sensor that detects the level of environmental light about the device. The device may control lighting of the at least one light source in response to the detected level of environmental light, i.e.: may include a light sensing cell. The light sensor can optionally be included in combination with a pedestrian detector.

According to another aspect, the invention broadly resides in apparatus for detecting a vehicle, the apparatus including:

at least one light source mounted to an object or structure and arranged to emit light onto and/or away from the object or structure;

a vehicle detector adapted to detect the presence of a vehicle proximate the object or structure; and

control circuitry connected or connectable to a power supply, wherein the control circuitry is adapted to light the at least one light source in response to a signal from the vehicle detector that indicates that a vehicle has been detected.

The object or structure may be a pole, pillar, beam, strut, shelf or other fixture, an air conditioning unit, a skip, storage frame or other object. In general, the object or structure may be anything that may cause damage to a vehicle if the vehicle collides with it and/or which may be damaged if a vehicle collides with it.

In the preferred embodiment as presently contemplated, the vehicle detector may be a passive infrared (PIR) sensor, ultrasonic detector, or similar detecting device. Other vehicle sensors may be used, including other motion sensors, a pressure mat, or an actuator located to be contacted by a vehicle travelling towards the fixture and arranged not to damage the vehicle by such contact.

The at least one light source may include a light source that is flashed on and off. In one embodiment the device includes one or more strobe or LED lights, preferably a plurality of such lights. The lights may be flashed on an off substantially randomly, for example in a random or substantially random sequence.

According to an even further aspect, the invention broadly resides in a method of fitting a vehicle alert device to an object or structure, the method comprising:

providing a light source on or near the object or structure so that when the light source is on it lights the object or structure and/or emits light away from the object or structure in a direction from which a vehicle may approach the object or structure;

arranging an electronic vehicle detector proximate to the object or structure so as to detect when a vehicle approaches the object or structure;

connecting the light source and the vehicle detector to a control circuit arranged to light the light source in response to a signal from the vehicle detector indicating that a vehicle has been detected; and

connecting a power supply to the control circuit, wherein the power supply is suitable for powering the light source and providing any power required for the control circuit and the vehicle detector.

The object or structure may be fixture. The fixture may be located within a car park.

The method may further comprise providing a light sensor in communication with the control circuit, the light sensor detecting the amount of light on or around the object or structure, and wherein control circuit is arranged to light the light source in response to a from the ht sensor that indicates that the detected level of light is below a certain intensity.

The method may further include using a strobe light as the light source. Still further, the method may include connecting a plurality of light sources to the control circuit, wherein the control circuit lights the plurality of light sources when the vehicle detector generates a signal that indicates that a vehicle has been detected. Each of the plurality of light sources may be a strobe light. The plurality of strobe lights may be lit in a substantially random sequence.

According to another aspect, the invention broadly resides in a pedestrian alert device, the device including:

a portable housing having a base and a stalk extending from the base, wherein the stalk is relatively narrow in comparison to the base;

a plurality of dc powered flashing lights in the stalk, wherein the lights are arranged to emit flashing light substantially horizontally away from the housing in substantially the same direction, and wherein the lights are located at different heights along the stalk;

an infrared pedestrian detector that detects the presence of a pedestrian proximate to the pedestrian alert device; and

control circuitry connected or connectable to a de power supply, wherein the control circuitry is adapted to provide power from said dc power supply to the lights when the pedestrian detector detects a pedestrian, causing the lights to light in an apparently random manner. Preferably, the lights are strobe or LED lights.

According to a still further aspect, the invention resides in an alert device including:

a portable housing having a base and a stalk extending from the base, wherein the stalk is relatively narrow in comparison to the base;

a plurality of dc powered flashing lights in the stalk, wherein the lights are arranged to emit flashing light substantially horizontally away from the housing in substantially the same direction, and wherein the lights are located at different heights along the stalk;

an infrared detector that detects the presence of a moving object proximate to the alert device; and

control circuitry connected or connectable to a dc power supply, wherein the control circuitry is adapted to provide power from the dc power supply to the lights when the detector detects a moving object, causing the lights to light in an apparently random manner.

Preferably, the detector is suitable for detecting a pedestrian or vehicle, and the device includes one or more non-strobe lights and reflectors.

According to another aspect the invention resides in a device including:

a portable housing having a base and a stalk extending from the base;

one or more dc powered strobe lights in the stalk;

one or more dc powdered non-strobe lights in the stalk;

a first detector that is capable of detecting the presence of a moving object proximate to the alert device;

a second detector that is capable of detecting the level of environmental light about the device;

control circuitry connected or connectable to a dc power supply,

wherein the control circuitry is adapted to:

provide power from the dc power supply to the one or more strobe lights, when the first detector detects the presence of a moving object and when the level of environment light about the device falls below a predetermined level, and

provide power from the dc power supply to the one or more non-strobe lights when the level of environmental light about the device falls below a predetermined level.

Preferably two or more strobe lights are positioned at different heights on the stalk and separated by non-strobe led lights, and the strobe lights pulse out of synchronization with each other when activated by the first detector. Also preferred is that the strobe lights and non-strobe led lights emit light in the same direction. In an alternative embodiment, the strobe lights can be replaced by flashing LED lights, or other similar high intensity flashing lights.

The use of a combination of flashing and non-flashing lights has been found to be particularly advantageous in alerting pedestrians and/or vehicles to the existence of the alert device, whilst also providing guidance to the pedestrian and/or vehicle with respect to their distance from the device. Thus, according to a preferred embodiment of the invention it is desirable for one or more non-flashing lights in the alert device to be activated once the environmental light drops below a predetermined level, and that flashing lights, such as strobe lights, in the device be activated upon detection of a moving object proximal to the device. Preferably any lights are non directional and comply with Road Traffic Authority standards.

Further embodiments of the aforementioned aspects of the invention and/or additional aspects of the invention will become apparent from the following description, given by way of example of currently contemplated preferred embodiments and with reference to the accompanying drawings.

### BRIEF DESCRIPTION OF THE DRAWINGS

FIG. 1: shows a side view of a pedestrian alert device.

FIG. 2: shows an embodiment of circuitry that may be used in the pedestrian alert device shown in FIG. 1.

FIG. 3: shows a very diagrammatic representation of a permanent pillar alert device, which may be located within a car park.

FIG. 4: shows a front view of a T-top portable bollard alert device of the invention.

FIGS. 5a and 5b: shows a side and bottom view of a strobe light for use in the alert device of FIG. 4.

FIG. 6 depicts a side view of a fixed or semi-fixed pedestrian alert device of the invention.

FIG. 7 depicts a network of pedestrian alert devices according to the invention.

### DETAILED DESCRIPTION OF THE EMBODIMENTS

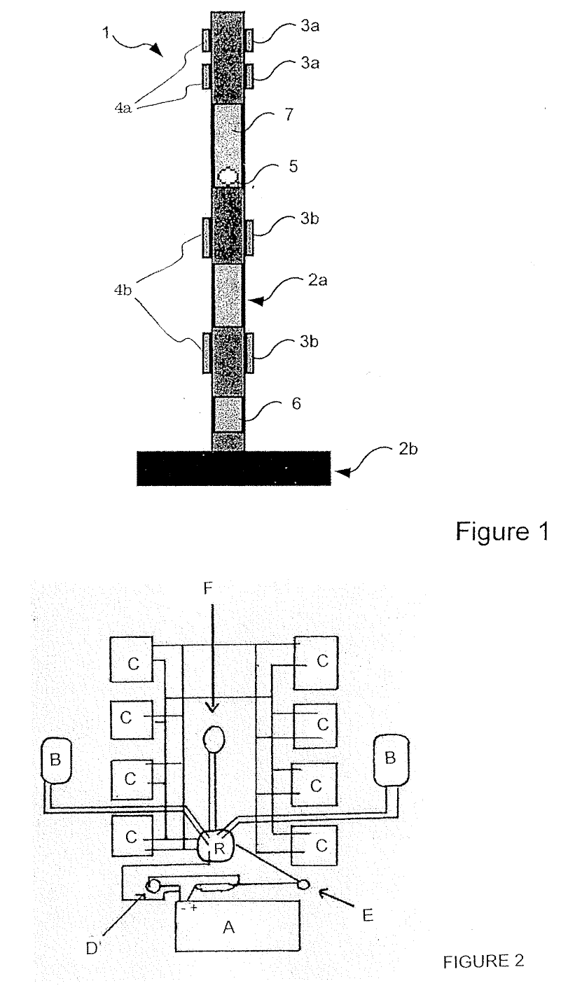

FIG. 1 shows a side view of an embodiment of an alert device of the present invention. The alert device is a pedestrian alert device 1. The pedestrian alert device 1 may be used, for example, at a pedestrian crossing to signal to drivers, or assist in the signaling to drivers, that a pedestrian is at the crossing. The pedestrian alert device 1 may also be used at a site where road works are being conducted. For example, the pedestrian alert device 1 may be located towards the periphery of the road works site so that people working on the site are generally always located on an opposite side of the pedestrian alert device 1 to traffic. The pedestrian alert device 1 may also have application elsewhere.

The pedestrian alert device 1 includes a housing, which in this embodiment includes a stalk 2a supported by a base 2b. The stalk may be constructed from a high impact polymer material, which is preferably brightly coloured with high visibility, for example in a fluorescent orange colour. Alternatively, the housing can be manufactured from any rigid material including steel and aluminium.

The stalk 2a may extend upwards approximately 1.5 metres from the base 2b. In other embodiments, the housing may be anywhere between approximately 1 m and 2 m tall. Lower or higher housings may also be used, with lower housings perhaps being less visible and higher housing being more difficult to transport and handle. The present inventors have discovered that a housing with a height of approximately 1 m is particularly well suited to automotive traffic control, including high speed areas of around 100 km/hr.

The base 2b may also be constructed from a high impact polymer material and may either attach to the stalk 2a or be formed integral with the stalk 2a. Alternatively, the base may be constructed from a different material, such as rubber and may also be weighted or have a significantly higher density than the stalk, to add stability to the pedestrian alert device 1.

The pedestrian alert device 1 may be portable and in the currently preferred embodiment is dimensioned so as to be readily movable by a single person. The materials and components may be selected so that the pedestrian alert device 1 weighs less than 20 kilograms, more preferably less than 10 kilograms and perhaps less than 5 kilograms. The stalk 2a may include one or more handles (not shown) to facilitate carriage of the pedestrian alert device 1 by hand. For example, a pedestrian alert device 1 standing approximately 1.5 metres tall may have a handle at the top of the stalk 2a and a handle along the side of the stalk 2a.

The shape of the housing is not limited to the shape shown in FIG. 1, although this shape represents the currently contemplated preferred embodiment. This embodiment may provide a pedestrian alert device 1 that is clearly visible, is not particularly susceptible to being moved or toppled by wind, and which facilitates transport to and from sites as required.

The pedestrian alert device 1 includes at least one light source. In the embodiment shown in FIG. 1, the pedestrian alert device 1 includes eight light sources, including two upper lights 3a and two lower lights 3b facing a first direction, and two upper lights 4a and two lower lights 4b facing the opposite direction. A configuration of lights facing in opposite directions may be useful for pedestrian crossings where there is two-way traffic. However, the lights 4a, 4b may be omitted in alternative embodiments.

Having light sources at various heights may assist to increase the visibility of the pedestrian alert device 1 to a driver of a vehicle approaching the pedestrian alert device 1. In addition, having two lights located towards the top of the stalk 2a (at about 1.0 m-2 m from the ground) may also increase the visibility of the pedestrian alert device 1, as the top of the stalk 2a may be located approximately in the middle of the vertical sight range of many drivers.

The pedestrian alert device 1 may light the lights 3a, 3b, 4a and 4b when a pedestrian is detected and extinguish the lights when a pedestrian is not detected. For this purpose, the pedestrian alert device 1 further includes a pedestrian detector 5. The pedestrian detector 5 is in the embodiment shown in FIG. 1 a passive infrared (PIR) sensor. For a pedestrian crossing, the PIR sensor may be located so as to have a field of view and effective detection field that includes the width of a road from about the kerb edge or just beyond the kerb edge onto the roadside to about the centre of the road. Different pedestrian alert devices 1 may be supplied, depending on the width of the road. For example, a single to two lane road may require a different pedestrian alert device 1 from a four or six lane road.

In another embodiment, a single detector may detect pedestrians substantially or entirely across the width of the road. In another embodiment, the pedestrian detector 5 may detect pedestrians on the footpath by a crossing, and/or at a location proximate the kerb, but not towards the middle of the road. The pedestrian detector 5 and or control circuitry for the pedestrian detector 5 may be set up to reduce false detections, for example by not causing lighting of the lights for a car driving by the device 1.

Alternative pedestrian detectors may be used. For example the pedestrian detector may be a video camera and a processor that receives images from the camera and determines whether a pedestrian is within the field of view of the camera, or within a particular part of the field of view of the camera. Another alternative may be a pressure mat, which is designed to be placed on the ground at a crossing point that may be next to the housing, so that a pedestrian stands on the pressure mat before crossing the road. Further alternative sensors may be used if required and a plurality of sensors of the same or different types may be used. For example, lights 3b and 4b may be lit permanently, when the alert device is in use, and lights 3a and 4a lit only when a pedestrian is detected. Alternatively, lights 3b and 4b may be connected to a second distinct detector, such as a light sensing detector, such that lights 3b and 4b come on permanently in periods of low visibility or at night.

The pedestrian alert device 1 may include a power source, for example one or more batteries. In one embodiment, the pedestrian alert device 1 may include a 12 volt battery and suitable lights 3a, 3b, 4a, 4b for a 12 volt battery. The ability of the pedestrian alert device 1 to turn the lights on and off as required may therefore prolong the operational period of the pedestrian alert device 1. Alternatively, the device can be switched manually on and off without being fitted with a detector.

The battery may be rechargeable and the pedestrian alert device 1 may include a recharge plug 6 to facilitate charging of the battery, for example by connecting a power cord between the recharge plug 6 and a mains supply. The pedestrian alert device 1 may also be able to be powered from a generator, mains supply, solar supply, or other external power source, for example by connecting a power supply cable to the recharge plug 6. When intended to be used in this way, the battery may be omitted. The alert device may optionally include a charge indicator, such as a led bar indicator, so as to allow a user to assess when the device will require recharging.

One or more of the light sources 3a, 3b, 4a, 4b may be flashed on and off. This may provide benefits of increased visibility and reduced power drain. The light sources maybe strobe lights, or alternatively flashing of the lights may be achieved by a control circuit, or suitable other controller such as a logic controller, or processor. The lights may be amber lights. The device can include two or more distinct types of light, including strobes and led lights. Preferably, the device includes one or more non-strobe led lights and one or more strobe lights. However, the device may include only LED lights.

The pedestrian alert device 1 may further include one or more reflective bands 7, to make the pedestrian alert device 1 more visible, at least in certain conditions.

FIG. 2 shows example circuitry for the pedestrian alert device 1, including a 12 volt dc battery A, two PR sensors B, eight light sources C, a recharge plug D, a switch B, a photo/light detector F and a relay R. The light sources C may be the light sources 3a, 3b, 4a, 4b and the PIR sensors B may each be a pedestrian detector 5.

The battery A powers a relay R, which is normally open. The relay R includes two control lines connected to the two PER sensors B. When the PER sensors B detect a light signal indicating the presence of a pedestrian, the relay R closes a circuit that includes the battery and the light sources C. The light sources C are strobe lights and therefore flash on when sufficiently charged. The eight light sources C therefore flash apparently randomly. A random flashing pattern may assist to make the pedestrian alert device 1 more visible.

The pedestrian alert device 1 may be able to be turned permanently on by operating a main switch B. In addition, the pedestrian alert device 1 may light some or all of the light sources under certain environmental conditions. The pedestrian alert device 1 may, for example, emit flashing light at or following sunset. In another embodiment, the lights may be lit to different intensities depending on the light conditions as detected by the photo/light sensor F. The photo/light sensor F may be adapted to detect when light from the sun is hitting the pedestrian alert device 1 at a low angle and the control circuitry may activate the light sources in response. Other conditions may optionally also or instead trigger lighting of the light sources.

Additional control circuitry may be provided to add further functionality. For example, the pedestrian alert device 1 may light the light sources for a certain period following the cessation of detection of movement. The control circuitry may further cat se some or all of the light sources to light at certain times of the day.

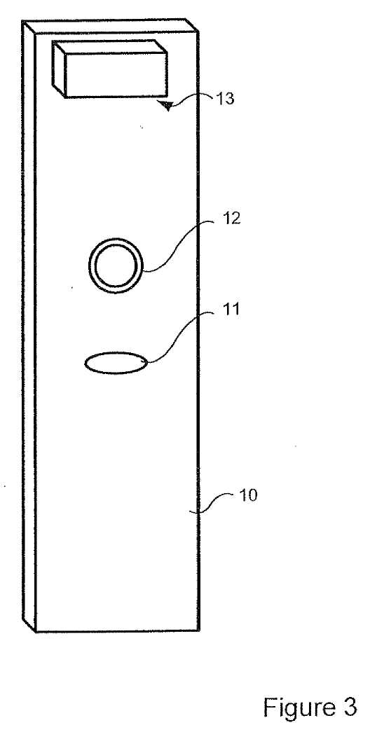

FIG. 3 shows an embodiment of a non-portable vehicle alert or safety device. A pillar 10, which may for example be in a car park, is provided with a PIR sensor 11 or other vehicle detector. An optional control circuit like that shown in FIG. 2 is connected to the PIR sensor 11 and lights a light 12, which may be a strobe light or other flashing light, when a vehicle is detected. More than one light 12, including lights at different heights may be provided. In addition, one or more lights 13 may be provided that are directed onto the pillar 10, so as to make the pillar more visible to a driver of a vehicle approaching the pillar 10.

The arrangement shown in FIG. 3 may be applied to other objects or structures. For example, sensors and lights may be provided for poles, shelfs, beams and/or struts. Sensors and lights may also be provided for objects such as skips, air conditioning units or other objects that may damage a vehicle or be damaged by a vehicle if a collision occurs.

Still further, a device similar to that shown in FIG. 1 may be provided adjacent to or otherwise near a structure or object to warn people or vehicles approaching the structure or object. Some or all of the lights may be directed onto the structure and object to illuminate it and some or all of the light may be directed away from the structure or object, in the direction from which a person or vehicle may approach the structure or object.

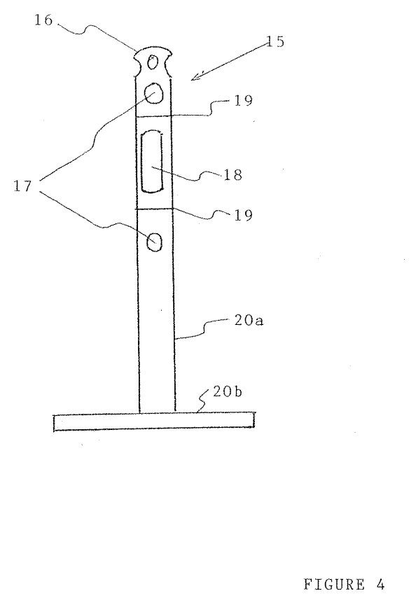

FIG. 4 shows a side view of a further preferred alert device of the present invention. The alert device is a pedestrian alert device 15. The pedestrian alert device 15 may be used, for example, at a pedestrian crossing to signal to drivers, or assist in the signaling to drivers, that a pedestrian is at the crossing. The pedestrian alert device 15 may also be used at a site where road works are being conducted. For example, the pedestrian alert device 15 may be located towards the periphery of the road works site so that people working on the site are generally always located on an opposite side of the pedestrian alert device 15 to traffic. The pedestrian alert device 15 may also have application elsewhere.

The pedestrian alert device 15 includes a housing, which in this embodiment includes a stalk 20a supported by a base 20b. The stalk may be constructed from a high impact polymer material, which is preferably brightly coloured, for example in a bright orange colour. The stalk 20a may extend upwards approximately 1.2 metres from the base 20b. In other embodiments, the housing may be anywhere between approximately 1 m and 2 m tall, but is preferably in the range of 1.0 to 1.5 metres. Lower or higher housings may also be used, with lower housings perhaps being less visible and higher housing being more difficult to transport and handle.

The base 20b may also be constructed from a high impact polymer material and may either attach to the stalk 20a or be formed integral with the stalk 20a. Alternatively, the base may be constructed from a different material, such as rubber and may also be weighted or have a significantly higher density than the stalk, to add stability to the pedestrian alert device 15.

The pedestrian alert device 15 may be portable and in the currently preferred embodiment is dimensioned so as to be readily movable by a single person. The materials and components may be selected so that the pedestrian alert device 10 weighs less than 20 kilograms, more preferably less than 10 kilograms and perhaps less than 5 kilograms. The stalk 20a may include one or more handles to facilitate carriage of the pedestrian alert device 15 by hand. For example, a pedestrian alert device 15 may have a handle 16 at the top of the stalk 2a. Alternatively, alert device 15 can have a handle (not shown) along the side of the stalk 2a.

The shape of pedestrian alert device 15 is clearly visible, is not particularly susceptible to being moved or toppled by wind, and facilitates transport to and from sites as required.

In the embodiment shown in FIG. 4, the pedestrian alert device 15 includes three light sources, including two strobe lights 17 and one non-strobe light 18 facing a first direction. A similar arrangement of lights may optionally face the opposite direction. This latter configuration of lights facing in opposite directions may be useful for pedestrian crossings where there is two-way traffic. The use of a combination of flashing and non-flashing lights has been found to be particularly advantageous in alerting pedestrians and/or vehicles to the existence of the alert device, whilst also providing guidance to the pedestrian and/or vehicle with respect to their distance from the device. The non-strobe lights on the alert device provide a permanent light and therefore assist in aiding the pedestrian or vehicle to judge its distance from the alert device, whereas the strobe lights aid in bringing the alert device to the attention of the pedestrian or vehicle. The skilled addressee will appreciate that the strobe lights of the embodiment of FIG. 4 could be substituted by other high intensity flashing lights, such as flashing LED lights.

Having light sources at various heights may assist to increase the visibility of the pedestrian alert device 15 to a driver of a vehicle approaching the pedestrian alert device 15. In addition, lights located towards the middle and top of the stalk 20a may increase the visibility of the pedestrian alert device 15, as the top of the stalk 20a may be located approximately in the middle of the vertical sight range of many drivers.

The pedestrian alert device 15 may have light 18 lit when visibility is poor, such as at night or during foggy or rainy weather. Strobe lights 17 may be activated when a pedestrian or vehicle is detected and extinguish when a pedestrian or vehicle is not detected. For this purpose, the pedestrian alert device 15 may optionally further include a pedestrian detector (not shown) and discussed in greater detail above with respect to FIG. 1. Alternatively, both lights 17 and 18 may be activated when a pedestrian or vehicle is detected and otherwise remain unlit.

Further alternative sensors may be used if required and a plurality of sensors of the same or different types may be used. For example, light 18 may be connected to a distinct detector to strobe lights 17, such as a light sensing detector, such that light 18 will turn on in periods of low visibility or at night, whereas strobe lights 17 only turn on when a vehicle or pedestrian is detected.

The pedestrian alert device 15 may include a power source, for example one or more batteries. The ability of the pedestrian alert device 15 to turn the lights on and off as required may therefore prolong the operational period of the pedestrian alert device 15. The battery may be rechargeable and the pedestrian alert device 15 may include a recharge plug (not shown) to facilitate charging of the battery, for example by connecting a power cord between the recharge plug and a mains supply or by one or more solar panels. The pedestrian alert device 15 may also be able to be powered from a generator, mains supply or other external power source, for example by connecting a power supply cable to the recharge plug. When intended to be used in this way, the battery may be omitted.

The lights in the alert device of FIG. 4 may be of different colours. For example, non strobe light 18 may be amber, whereas strobe lights 17 may be a combination of colours such as red and blue. One particularly preferred embodiment is where the flashing lights are blue and red, and the non-flashing centre light is blue, including the arrangement where the lower flashing light is red and the upper one is blue. Another particularly preferred embodiment is where all lights are amber.

The pedestrian alert device 15 may further include one or more reflective bands 19, to make the pedestrian alert device 15 more visible, at least in certain conditions. Alternatively, the complete area between the upper and lower 19 on FIG. 4 can be reflective.

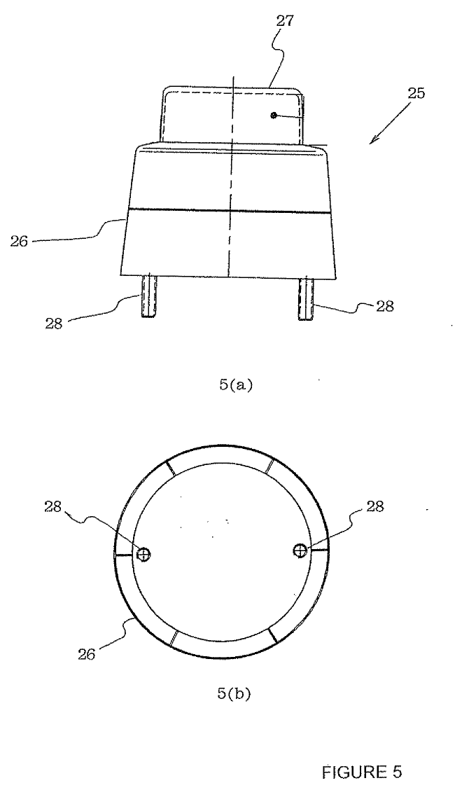

FIG. 5 depicts a preferred light 25 which is particularly well suited to use with the alert device of either FIG. 1 or 4. FIG. 5a is a view from a side of the light, whereas FIG. 5b is view of the bottom of the light. Light 25 includes body 26, coloured lens 27 and securing pins 28. The light 25 is preferably a strobe light, of 8-15 volts DC and 150 mA and a flash rate of 80-150 per minute, or more preferably approximately 110-120 per minute, or lights having similar specifications.

The light 25 can be constructed of any suitable material, however is preferably made of a synthetic polymer or similar material. Lens 27 can be of any colour, for example red, blue or amber.

In positioning light 25 in an alert device, for example the alert device of FIG. 1 or 4, the light 25 is inserted into the stalk and brought to rest such that the lens 27 faces out from the stalk. The lens 27 can either protrude from an opening in the stalk, sit in an opening of the stalk, or be held in the stalk such that the lens 27 is visible from outside the stalk through an opening in the stalk. To hold the light 25 in this position, stops (not shown) located on securing pins 28 are positioned to butt against the opposing internal wall of the stalk, and hold the light 25 in place. For example, securing pins 28 may be treaded to receive rubber stops (not shown). Once the light 25 is correctly positioned in the alert device, the stops can be screwed away from the light body 25 and thus wedge the light 25 inside the stalk with the lens 27 visible from outside the alert device.

It is envisaged that the alert device of the invention may be of particular utility at pedestrian crossings, and the like, especially when connected in a network. In this environment, it is envisaged that two or more devices could be configured together and activated by a pedestrian using the crossing. For example, activation of a manual switch on one device may be used to simultaneously activate a number of similar devices, causing the pedestrian crossing to be easily identified by a driver, even a driver travelling at high speed. Alert devices in a network can be hardwired together, or connected via a wireless connection.

According to a particularly preferred embodiment of the invention, a network of four or more alert devices is positioned on the edge of a road and at the corners of a pedestrian crossing. The alert devices are activated by a person crossing the pedestrian crossing, causing the lights of the alert devices to be switched on and thereby warn traffic that the crossing is in use. Lights will typically be activated for a sufficient period of time to allow a person to safely cross the road and the actual activation time can be adjusted to suit various road widths, slopes, and the like. Activation can be by a manual switch located on one or more of the alert devices, or via a detection device, the various options for which are discussed in greater detail above. Such a network of alert devices for use with a pedestrian crossing can be powered by a battery and/or solar cell arrangement, or connected to mains power. Such an arrangement of alert devices may be portable, or permanently fixed in position around a crossing.

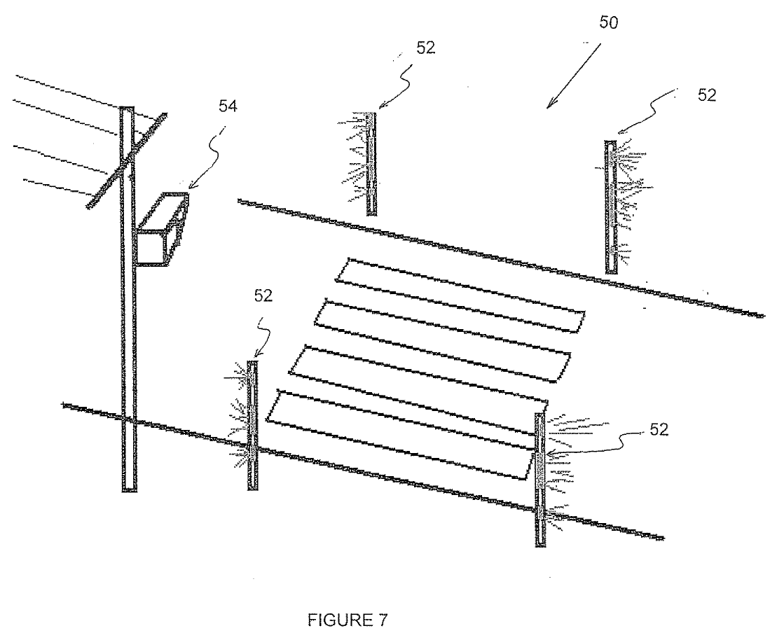

Such an arrangement is depicted in FIG. 7, in which a typical pedestrian crossing 50 is surrounded by four alert devices 52. Upon activation by a pedestrian the alert devices 52 emit flashing light. In this embodiment, the alert devices 52 can be powered by a solar panel 54, or be battery powered which is capable of being recharged by solar panel 54.

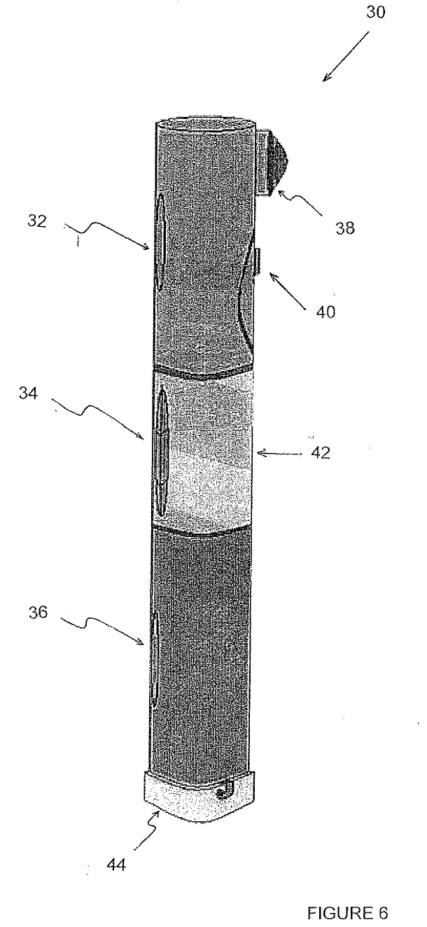

The alert device 30 of FIG. 6 is suitable for use in the network depicted in FIG. 7. In FIG. 7, alert device 30 includes three lights (32, 34 and 36). Typically, the middle light 34 will remain illuminated during periods of low light, whereas lights 32 and 36 will flash upon activation of the alert device. As discussed elsewhere, activation can be manual or via a detector. Lights 32 and 36 may optionally be reflectors.

The alert device 30 includes a reflective panel 42, and permanent, or at least semi-permanent, lock down plate 44. Plate 44 allows for the device 30 to be fixed to the ground and locked in one location for extended use. The device 30 also includes a key locked switch 40 for adjusting the activation time, and a push button 38 which may also optionally be a component of the pedestrian detector.

Where in the foregoing description reference has been made to any integer having a known equivalent, then that equivalent is hereby incorporated herein as if individually set forth.

It will be understood that the invention disclosed and defined in this specification extends to all alternative combinations of two or more of the individual features mentioned or evident from the text or drawings. All of these different combinations constitute various alternative aspects of the invention.

It will also be understood that the term “comprises” (or its grammatical variants) as used in this specification is equivalent to the term “includes” and should not be taken as excluding the presence of other elements or features.

We claim:

1. An alert device, the device including a housing containing one or more flashing light sources and one or more non-flashing light sources, wherein both flashing and non-flashing light sources are arranged to emit light away from the housing.

2. The alert device of claim 1, wherein the housing includes a base and a vertical stalk, and wherein the vertical stalk includes the flashing and non-flashing light sources.

3. The alert device of claim 2, wherein the stalk is approximately 0.8-2.0 metres tall.

4. The alert device of claim 3, wherein the stalk is approximately 0.0-1.5 metres tall.

5. The alert device of claim 4, wherein the one or more flashing light sources and the one or more non-flashing light sources are substantially vertically aligned.

6. The alert device of claim 5, wherein the stalk includes two flashing light sources and one non-flashing light source facing a first direction.

7. The alert device of claim 6, wherein the stalk includes two flashing light sources and one non-flashing light source facing a second direction.

8. The alert device of claim 6, wherein the one non-flashing light source is located between the two flashing light sources.

9. The alert device of claim 8, wherein the two flashing light sources are of different colours.

10. The alert device of claim 9, wherein the two flashing h sources when activated flash in a substantially random sequence.

11. The alert device of claim 10, wherein the one non-flashing light source is larger in size than one of the two flashing light sources.

12. The alert device of claim 11, further including reflective material facing outwards from the housing.

13. The alert device of claim 12, wherein the reflective material is reflective tape positioned between the two flashing light sources.

14. The alert device of claim 13, wherein the device is portable.

15. The alert device of claim 14, wherein the two flashing lights are strobe lights, LED lights, or combination thereof.

16. The alert device of claim 15, wherein the base has a width of approximately 0.5-0.75 metres.

17. The alert device of claim 16, including a detector adapted to detect the movement of an object into an area proximate to the housing, and control circuitry connected or connectable to a power supply, wherein the control circuitry is adapted to light the two flashing light sources in response to a signal from the detector indicating that a moving object has been detected.

18. The alert device of claim 17, wherein the power supply is a battery contained within the housing.

19. The alert device of claim 17, wherein the power supply includes a solar cell.

20. The alert device of claim 9, wherein the detector is a passive infrared (PIR) sensor.

21. The alert device of claim 19, wherein the detector is a pedestrian detector comprising a pressure pad located proximate the housing, and connected to the control circuitry, or a button or other device operable by a pedestrian to indicate his or her presence at the device.

22. The alert device of claim 20, wherein the device further includes a light sensor that detects the level of environmental light about the device and the light sensor controls lighting of the at least one non-flashing light source in response to the detected level of environmental light.

23. A traffic alert device, the device including:
a housing having a base and a stalk, wherein the stalk extends from the base and is relatively narrow in comparison to the base;
one or more dc powered flashing lights and one or more dc powered non-flashing lights in the stalk, wherein the lights are arranged to emit light substantially away from the housing in a first direction, and wherein the lights are located at different heights along the stalk.

24. The device of claim 23, including a detector that detects the presence of a moving object proximate to the alert device; and
control circuitry connected or connectable to a dc power supply, wherein the control circuitry is adapted to provide power from the dc power supply to the flashing lights when the detector detects a moving object, causing the flashing lights to light in an apparently random manner.

25. The alert device of claim 24, wherein the alert device includes a switch to activate the non-flashing lights.

26. The alert device of claim 25, wherein the switch is activated manually or activated by a predetermined level of environmental light.

27. A portable pedestrian or traffic alert device, the device including:
a portable housing having a base and a stalk extending from the base;
one or more dc powered flashing lights in the stalk;
one or more dc powdered non-flashing lights in the stalk;
a first detector that is capable of detecting the presence of a moving object proximate to the alert device;
a second detector that is capable of detecting the level of environmental light about the device;
control circuitry connected or connectable to a dc power supply,
wherein the control circuitry is adapted to:
provide power from the dc power supply to the one or more flashing lights, when the first detector detects the presence of a moving object and when the second detector detects the level of environment light about the device below a predetermined level, and
provide power from the dc power supply to the one or more non-flashing lights when the level of environmental light about the device falls below a predetermined level.

28. The alert device of claim 27, wherein two or more flashing lights are positioned at different heights on the stalk and separated by one or more non-flashing lights.

29. The alert device of claim 28, wherein the two or more flashing lights in the stalk are not synchronized with each other when activated by the first detector.

30. A pedestrian alert network comprising two or more alert devices of claim 22, wherein the alert devices are connected such that activation of one alert device also activates the other alert devices in the network.

31. The network of claim 30, wherein after a predetermined time period after activation the network is deactivated.
